(19) United States
(12) Patent Application Publication
(10) Pub. No.: US 2017/0140429 A1
(43) Pub. Date: May 18, 2017

(54) METHOD AND SYSTEM FOR PROVIDING ADVERTISEMENTS BASED ON SEMANTIC REPRESENTATIONS

(71) Applicant: Yahoo! Inc., Sunnyvale, CA (US)

(72) Inventors: Hao Cheng, Santa Clara, CA (US); Ben Shahshahani, Menlo Park, CA (US)

(21) Appl. No.: 14/938,956

(22) Filed: Nov. 12, 2015

(51) Int. Cl. G06Q 30/02; G06F 17/30

(52) U.S. Cl. CPC G06Q 30/0256; G06F 17/30654; G06Q 30/0275

(57) ABSTRACT

The present teaching relates to methods, systems, and programming for providing advertisements based on semantic representations. In one example, a request is obtained for advertisement. The request incorporates a query. The query is parsed to generate a semantic representation of the query. A plurality of advertisements indexed by their respective semantic representations is obtained. Among the plurality of advertisements, one or more advertisements are determined whose semantic representations match the semantic representation of the query. The one or more advertisements are provided as a response to the request.

### BACKGROUND

1. Technical Field

The present teaching relates to methods, systems, and programming for advertisements. Particularly, the present teaching is directed to methods, systems, and programming for providing advertisements based on semantic representations.

2. Discussion of Technical Background

The advancement in the Internet has made it possible to provide advertisements to users through the Internet. A query from a user can be leveraged for selecting relevant advertisements to be presented to the user, e.g. along with a search result in response to the query.

Most existing techniques of ad selection focus on matching the query with advertisements at text token level, e.g. by determining whether the query text matches the text of bid terms submitted by advertisers in association with the advertisements during a bidding process. Some existing works utilize users' click feedbacks to find relevant query pairs or groups. But this data-driven approach typically requires a large amount of user data and still relies on text token level matching without understanding the meaning of the queries.

Therefore, there is a need to develop techniques to provide advertisements to overcome the above drawbacks.

### SUMMARY

The present teaching relates to methods, systems, and programming for advertisements. Particularly, the present teaching is directed to methods, systems, and programming for providing advertisements based on semantic representations.

In one example, a method, implemented on a machine having at least one processor, storage, and a communication platform capable of connecting to a network for providing advertisement is disclosed. A request is obtained for advertisement. The request incorporates a query. The query is parsed to generate a semantic representation of the query. A plurality of advertisements indexed by their respective semantic representations is obtained. Among the plurality of advertisements, one or more advertisements are determined whose semantic representations match the semantic representation of the query. The one or more advertisements are provided as a response to the request.

In a different example, a system for providing an advertisement is disclosed, which comprises: a query semantic parser configured for obtaining a request for advertisement, wherein the request incorporates a query; and parsing the query to generate a semantic representation of the query; and an ad matching module configured for obtaining a plurality of advertisements indexed by their respective semantic representations; determining, among the plurality of advertisements, one or more advertisements whose semantic representations match the semantic representation of the query; and providing the one or more advertisements as a response to the request.

Other concepts relate to software for implementing the present teaching on providing advertisement. A software product, in accord with this concept, includes at least one machine-readable non-transitory medium and information carried by the medium. The information carried by the medium may be executable program code data, parameters in association with the executable program code, and/or information related to a user, a request, content, or information related to a social group, etc.

In one example, a machine-readable, non-transitory and tangible medium having information recorded thereon for providing advertisement is disclosed. The information, when read by the machine, causes the machine to perform the following: obtaining a request for advertisement, wherein the request incorporates a query; parsing the query to generate a semantic representation of the query; obtaining a plurality of advertisements indexed by their respective semantic representations; determining, among the plurality of advertisements, one or more advertisements whose semantic representations match the semantic representation of the query; and providing the one or more advertisements as a response to the request.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a high level depiction of an exemplary networked environment for providing advertisement based on semantic matching, according to an embodiment of the present teaching;

FIG. 2 is a high level depiction of another exemplary networked environment for providing advertisement based on semantic matching, according to an embodiment of the present teaching;

FIG. 3 illustrates parsing exemplary queries or ad related texts into a semantic frame, based on semantic rules, according to an embodiment of the present teaching;

FIG. 4 illustrates exemplary grammar operators supported in a semantic grammar, according to an embodiment of the present teaching;

FIG. 5 illustrates an example of a semantic grammar, according to an embodiment of the present teaching;

FIG. 6 illustrates implementing an exemplary semantic grammar with finite state transducers, according to an embodiment of the present teaching;

FIG. 7 shows exemplary ad related texts that may be parsed into semantic frames, according to an embodiment of the present teaching;

FIG. 8 shows an exemplary user interface, when an advertiser bids for a semantic frame, according to an embodiment of the present teaching;

FIG. 9 illustrates an exemplary diagram of a semantic matching based ad recommendation engine, according to an embodiment of the present teaching;

FIG. 10 is a flowchart of an exemplary process performed by a semantic matching based ad recommendation engine, according to an embodiment of the present teaching;

FIG. 11 illustrates an exemplary diagram of an ad semantic parser, according to an embodiment of the present teaching;

FIG. 12 is a flowchart of an exemplary process performed by an ad semantic parser, according to an embodiment of the present teaching;

FIG. 13 illustrates an exemplary diagram of an ad matching module, according to an embodiment of the present teaching;

FIG. 14 is a flowchart of an exemplary process performed by an ad matching module, according to an embodiment of the present teaching;

FIG. 15 depicts the architecture of a mobile device which can be used to implement a specialized system incorporating the present teaching; and

FIG. 16 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of providing advertisements based on semantic matching, realized as a specialized and networked system by utilizing one or more computing devices (e.g., mobile phone, personal computer, etc.) and network communications (wired or wireless). The method and system as disclosed herein aim at providing advertisements in a user's search result page in an effective and efficient manner.

One of the goals of advertisements is to sell a product and/or a service to users. A user may submit a query to search for information or products that the user has interest in. Based on the query, one or more advertisements can be determined to be relevant to the query and presented to the user in a search result page.

Disclosed herein includes novel methods and systems for providing advertisements to users based on semantic matching between query and bid terms. The system may parse and represent user query and bid terms by their respective semantic meaning, denoted as the semantic frame representation. The system may then index the semantic frames of the bid terms instead of the text token forms of the bid terms in an ad database. When a query comes in, the system will also parse the query into its semantic frame. The ad retrieval could be as simple as looking up bid terms that have the same or similar semantic frames as the query.

In addition to bid terms on which advertisers bid with the advertisements, the system may also index the advertisements using semantic frames of their other ad related texts. For example, an ad related text may include a title of the advertisement, an advertiser of the advertisement, a landing page associated with the advertisement, a tag associated with the advertisement, a description of the advertisement, or any other text that can represent the advertisement.

The terms “ad” and “advertisement” may be used interchangeably herein. The terms “semantic frame,” “semantic representation” and “semantic frame representation” may be used interchangeably herein.

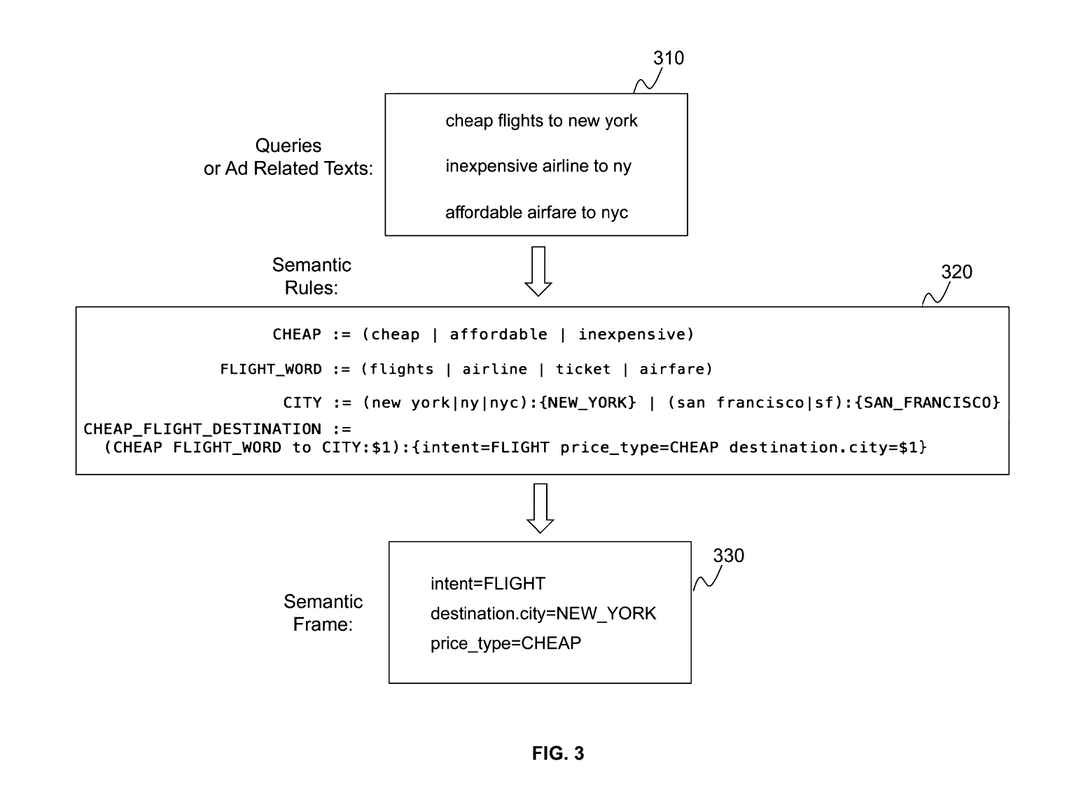

FIG. 3 illustrates parsing exemplary queries or ad related texts into a semantic frame, based on semantic rules, according to an embodiment of the present teaching. Consider the semantically equivalent queries or ad related texts 310: cheap flights to new york; inexpensive airline ticket to ny; affordable airfare to nyc.

In accordance with the present teaching, these different variations could all be represented as the following semantic frame 330:

intent=FLIGHT; destination_city=NEW_YORK; price_type=CHEAP.

The system may use a rule-based semantic parser to read an input string and convert it to the semantic form. For the above example, the system may use the following four semantic rules 320: rule “CHEAP:=(cheap|affordable|inexpensive) corresponds to the semantic meaning price_type=CHEAP; rule “FLIGHT_WORD:=(flights|airline|ticket|airfare) corresponds to the semantic meaning intent=FLIGHT; rule CITY:=(new York|ny|nyc):{NEW_YORK}|(san francisco|sf):{SAN_FRANCISCO} corresponds to the semantic meaning destination.city=NEW_YORK; and rule CHEAP_FLIGHT_DESTINATION is used to parse tokens respectively in order from the rules CHEAP, FLIGHT_WORD, CITY, and then convert them to the final semantic form 330. With such rule definitions, the system could parse many other different variations of the same semantic meaning, such as, inexpensive flights to nyc, affordable flights to ny, and so on.

The semantic frames disclosed in the present teaching can capture the inherent meaning and different variations and rewrites of a query and/or ad related texts that have the same semantic representation and are semantically equivalent and interchangeable for ad retrieval. Consequently, the coverage of ad searching can be improved without sacrificing semantic precision. Common patterns represented by the rules in the semantic grammar can be used across various other rules. Any improvement of the common patterns (for example, add a new word in the base rule, like adding “air flight” to rule FLIGHT_WORD) is automatically inherited by all the parent rules, which would start to parse new variations. The semantic frame representation not only can benefit the ad matching process, but also can be very useful for other components in a search ad system, e.g. click modeling to predict a user's probability of clicking a specific advertisement.

In one embodiment, the system may implement parsing input text to the semantic frame using a finite state transducer (FST), which may be a finite state machine with an input tape and output tape. For example, a rule-based semantic parser may comprise: semantic grammar, which defines a list of semantic rules; an FST generator, which parses the semantic grammar and creates the set of FSTs that corresponds to the semantic grammar; and an FST parser, which parses queries or bid terms with the FSTs corresponding to the semantic grammar.

In one example, semantic grammar is defined specifically for the ad matching purpose. Queries and bid terms may then be parsed into the semantic frames by the generated FSTs. The ad matching can happen at the semantic representation level. In an ad serving system, a new keyword server can be created where semantic frames are used as index key to the posting lists of bid terms and ads. Each semantic frame can also be viewed as a bag of semantic tokens. As such, the system can efficiently retrieve high quality matches based on similarity metric or a machine-learned ranking model.

The system also allows advertisers to bid on semantic frames directly. This would enable advertisers to more explicitly specify the semantic meanings of the queries or keywords on which they want to bid. For example, if an advertiser bids on the semantic frame “intent=FLIGHT; destination_city=NEW_YORK; price_type=CHEAP”, an ad platform may try to bid on all the keywords that fall into this semantic frame on the advertiser's behalf.

In addition, advertisers can also specify all of the variations of queries/keywords they want to buy. For example, an advertiser might write a rule like “(cheap|inexpensive|affordable) (flight|flights) to? (new york|ny|nyc)” to capture all the variants of queries that the advertiser want to buy.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

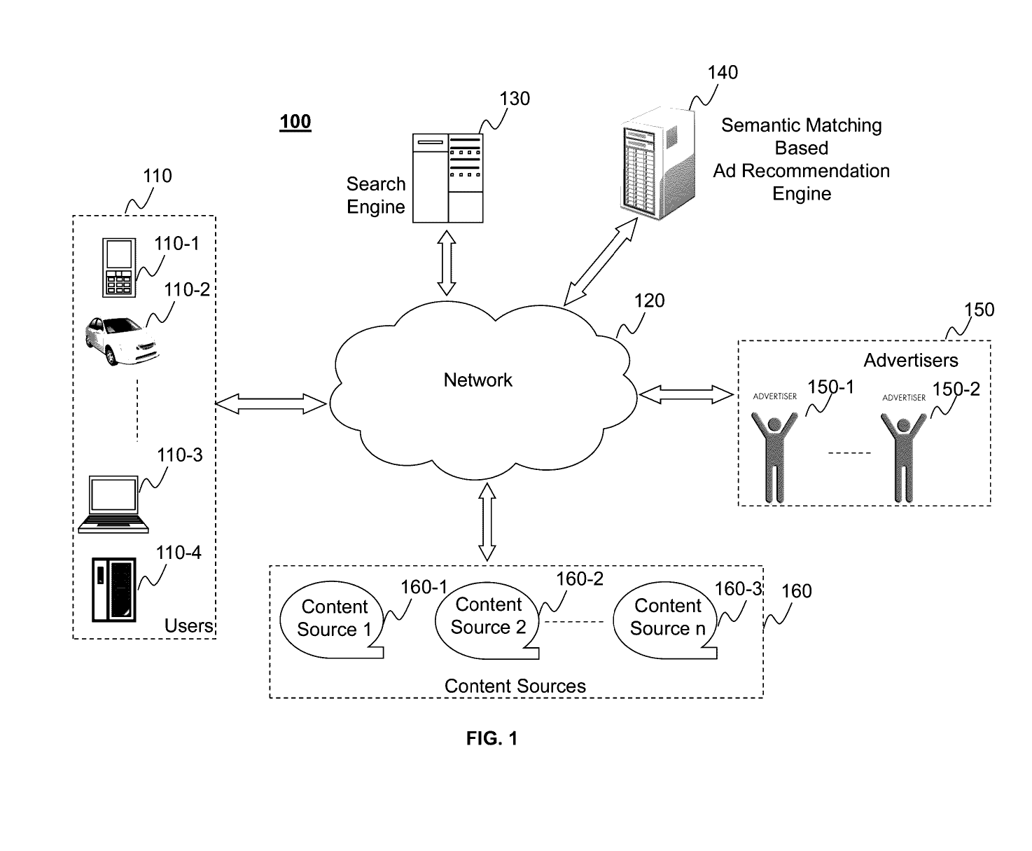

FIG. 1 is a high level depiction of an exemplary networked environment 100 for providing advertisement based on semantic matching, according to an embodiment of the present teaching. In FIG. 1, the exemplary networked environment 100 includes one or more users 110, a network 120, a search engine 130, a semantic matching based ad recommendation engine 140, one or more advertisers 150, and content sources 160. The network 120 may be a single network or a combination of different networks. For example, the network 120 may be a local area network (LAN), a wide area network (WAN), a public network, a private network, a proprietary network, a Public Telephone Switched Network (PSTN), the Internet, a wireless network, a virtual network, or any combination thereof. In an example of Internet advertising, the network 120 may be an online advertising network or ad network through which a company connects advertisers to web sites that want to host advertisements.

Users 110 may be of different types such as users connected to the network 120 via desktop computers 110-4, laptop computers 110-3, a built-in device in a motor vehicle 110-2, or a mobile device 110-1. In one embodiment, users 110 may be connected to the network 120 and able to interact with the search engine 130 and the semantic matching based ad recommendation engine 140 through wired or wireless technologies and related operating systems implemented within user-wearable devices (e.g., glasses, wrist watch, etc.). A user, e.g., the user 110-1, may send a request for content and/or advertisements to the search engine 130, via the network 120, and receive content and/or advertisements from the search engine 130 through the network 120.

The search engine 130 may be provided by a service provider that corresponds to an entity, an individual, a firm, or an organization, such as a television station, a newspaper issuer, a web page host, an online service provider, or a game server. The service provider may be an organization such as USPTO.gov, a content provider such as CNN.com and Yahoo.com, or a content-feed source such as tweeter or blogs. In one embodiment, the service provider includes entities that develop, support and/or provide online content via mobile applications (e.g., installed on smartphones, tablet devices, etc.).

Referring to the above example, the search engine 130 may search for content from the content sources 160 based on a request from a user. The request may incorporate a query. A content source may correspond to an entity where the content was originally generated and/or stored. The content sources 160 in the exemplary networked environment 100 include multiple content sources 160-1, 160-2 . . . 160-3.

When content is sent to the user 110-1, one or more advertising opportunities may be available for one or more advertisements to be presented with the content to the user 110-1, on a same web page, via a same application, or in a same user session. For an available advertising opportunity, the search engine 130 may send a request to the semantic matching based ad recommendation engine 140 for selecting advertisements based on the query.

The semantic matching based ad recommendation engine 140 may select and provide advertisements relevant to the query to be presented to the user. After receiving a request for advertisement from the search engine 130, the semantic matching based ad recommendation engine 140 may extract the query from the request and parse the query to generate a semantic frame for the query. In one example, the semantic matching based ad recommendation engine 140 has access to a plurality of advertisements that are indexed by their respective semantic frames. Each semantic frame may be either obtained from an advertiser's input or generated based on an ad related text associated with the advertisement. The semantic matching based ad recommendation engine 140 may select one or more advertisements whose semantic frames match the semantic frame of the query. The semantic matching based ad recommendation engine 140 may determine a matching score based on a degree of similarity between the semantic frame of the query and the semantic frame of each of the plurality of advertisements; rank the plurality of advertisements based on their respective matching scores; and select the one or more advertisements from the plurality of advertisements based on the ranking.

The parsing of the query and the ad related texts may be based on one or more semantic rules. The semantic matching based ad recommendation engine 140 can parse semantic grammar stored in a semantic grammar database; and generate the one or more semantic rules based on the parsed semantic grammar and at least one FST. In addition, the semantic matching based ad recommendation engine 140 may update the semantic grammar stored in the semantic grammar database based on information retrieved from a knowledge database.

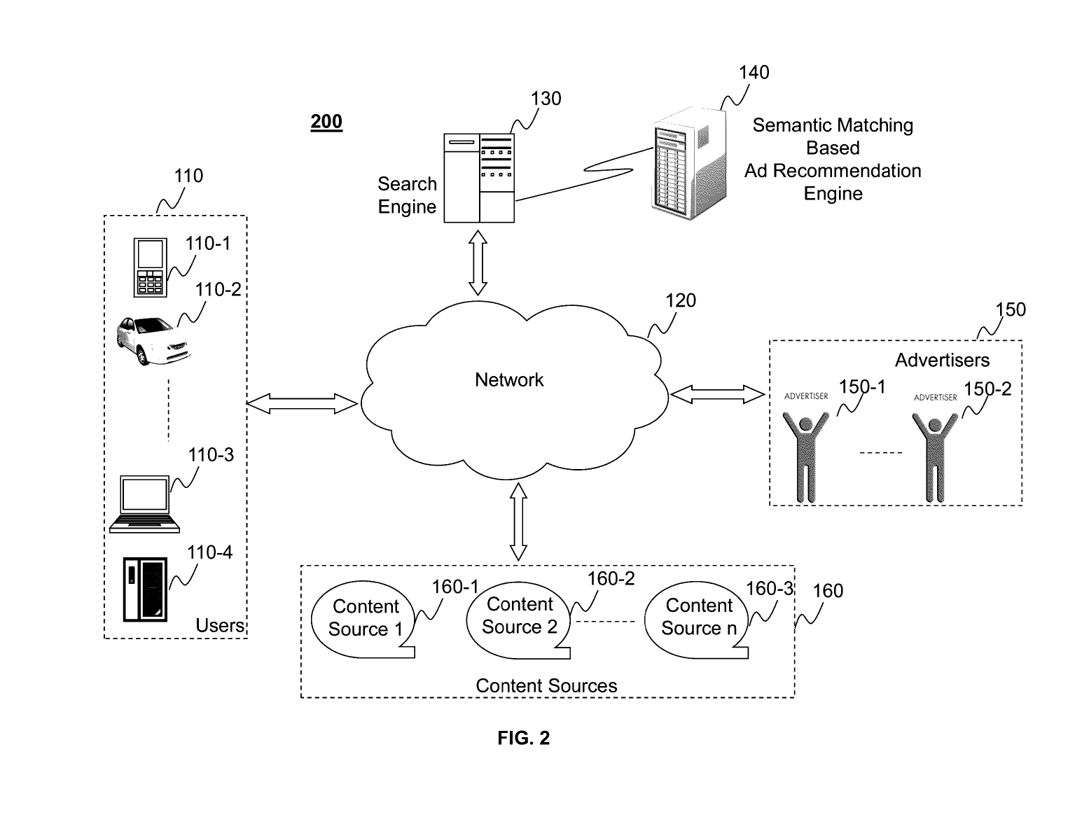

FIG. 2 is a high level depiction of another exemplary networked environment 200 for providing advertisements based on semantic matching, according to an embodiment of the present teaching. The exemplary networked environment 200 in this embodiment is similar to the exemplary networked environment 100 in FIG. 1, except that the semantic matching based ad recommendation engine 140 serves as a backend system for the search engine 130.

As discussed above, FIG. 3 illustrates parsing exemplary queries or ad related texts 310 into a semantic frame 330, based on semantic rules 320, according to an embodiment of the present teaching.

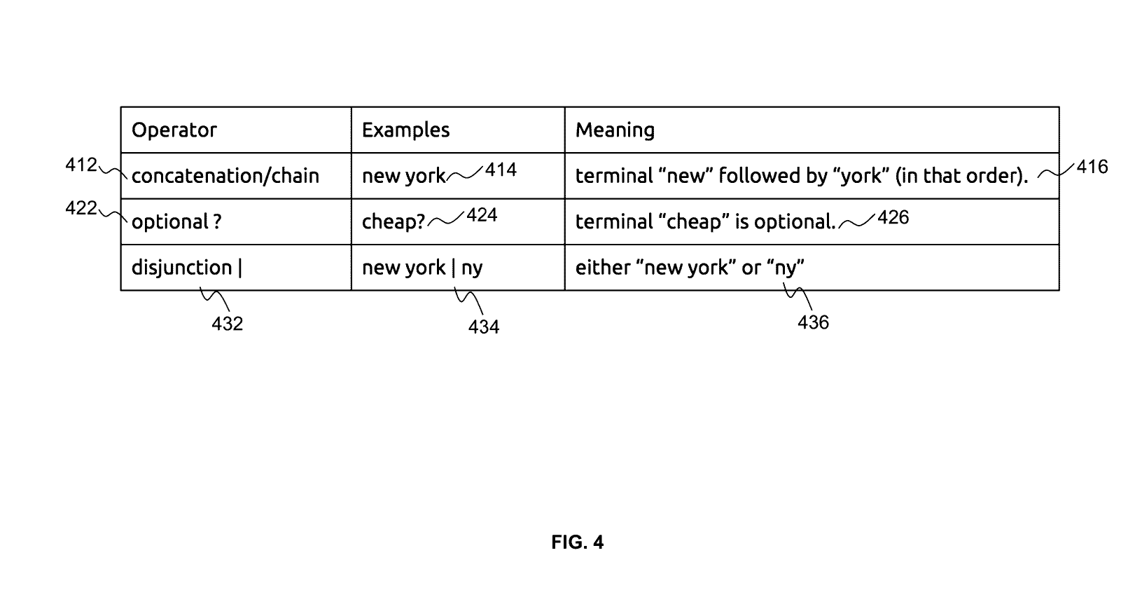

FIG. 4 illustrates exemplary grammar operators supported in a semantic grammar, according to an embodiment of the present teaching. In general, a semantic grammar may be a formal definition of semantic rules to determine how semantic frames should be interpreted. As shown in FIG. 4, a concatenation/chain operator “ ” 412 in an exemplary rule “new york” 414 has a meaning 416 that terminal “new” is followed by terminal “york” in that order; an optional operator “?” 422 in an exemplary rule “cheap?” 424 has a meaning 426 that terminal “cheap” is optional; a disjunction operator “|” 432 in an exemplary rule “new york|ny” 434 has a meaning 436 that either “new york” or “ny”.

In one example, the order of operators may be: optional is higher than concatenation, which is higher than disjunction. For example, an expression like “southwest airline ticket?|swa flights” may be used to parse 3 variants, i.e., “southwest airline ticket”, “southwest “airline”, “swa flights”. A parenthesis may be used to group an expression. For example, the expression “(southwest|swa) (airline ticket?|flights)” may be used to parse six different strings.

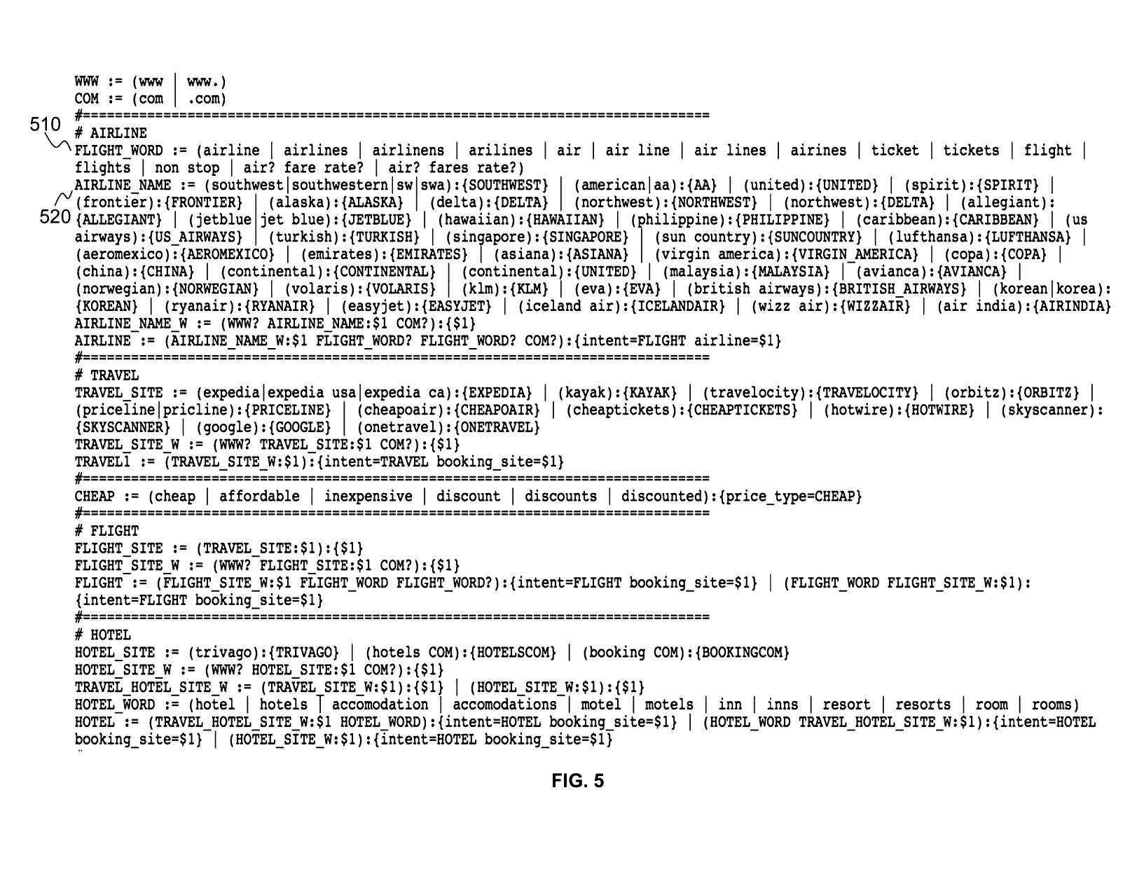

FIG. 5 illustrates an example of a part of a semantic grammar, according to an embodiment of the present teaching. In practice, at least some of the semantic grammar may be generated and/or updated based on information retrieved from a knowledge database. For example, different terminals defined under the rule FLIGHT_WORD 510 in FIG. 5 may be generated based on a dictionary; and different terminals defined under the rule AIRLINE_NAME 520 in FIG. 5 may be generated and/or updated based on a knowledge source like Wikipedia. It can be understood that some of the semantic grammar may be generated and/or updated based on human inputs, e.g. from a programmer or a manager. It can also be understood that a hybrid of human edit and data mining may be used to define semantic rules.

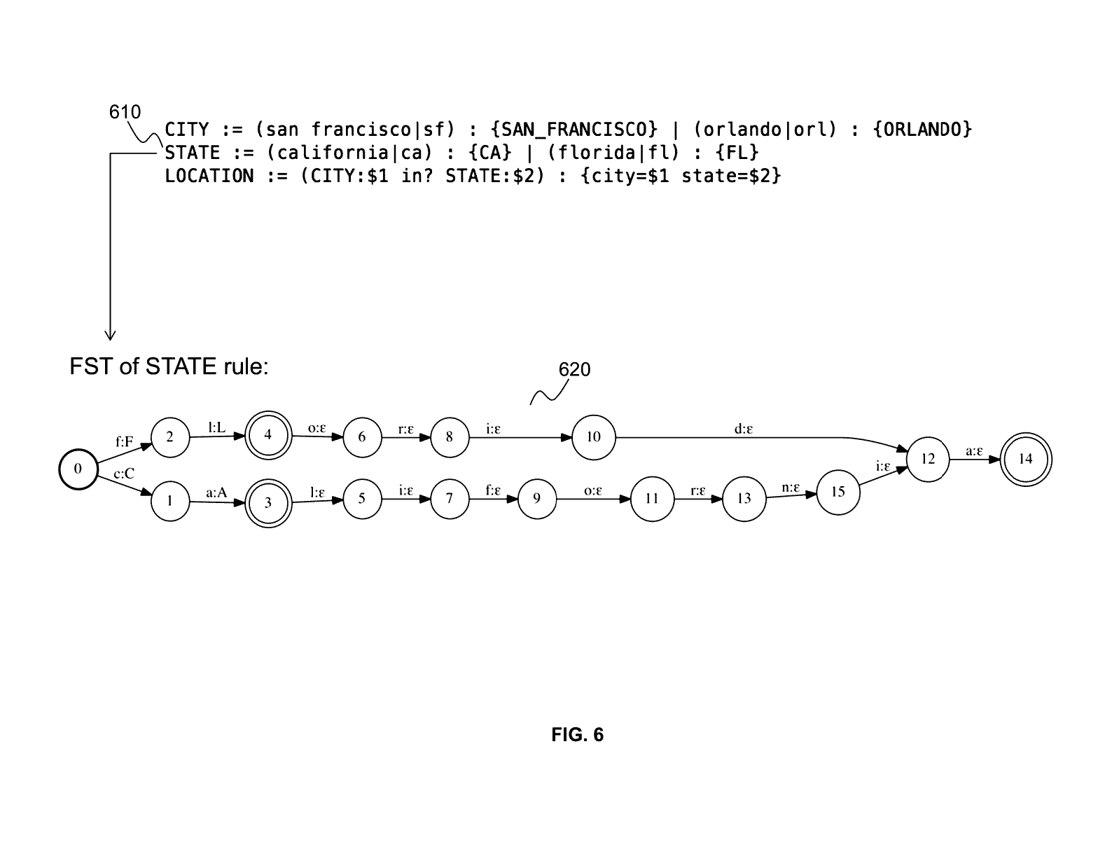

FIG. 6 illustrates implementing an exemplary semantic grammar with finite state transducers, according to an embodiment of the present teaching. A finite state transducer (FST) is a finite state machine with an input tape and an output tape. An FST comprises a number of states and edges to define the transition between states. For example, an FST may include: one start state which may be labeled as State 0; one or multiple end states that may be represented by double circles; an edge that connects two states. Each edge may have input tokens and output tokens. It means that, from the source state of the edge, if the input tokens are parsed, it will be shifted to the destination state of the edge and the corresponding output tokens will be produced. An FST may also include a special epsilon token ε. If ε is the input label of an edge, it means that the transition does not need to consume any input. If ε is the output label of an edge, it means that it emits no output for this transition.

FST has many nice characteristics and support standard operations. Accordingly, the system may construct chains of FSTs defined by the semantic grammar. For example, as shown in FIG. 6, the system may construct chains of FSTs 620 corresponding to the rule “STATE:=(california|ca):{CA}|(florida|fl):{FL}” 610.

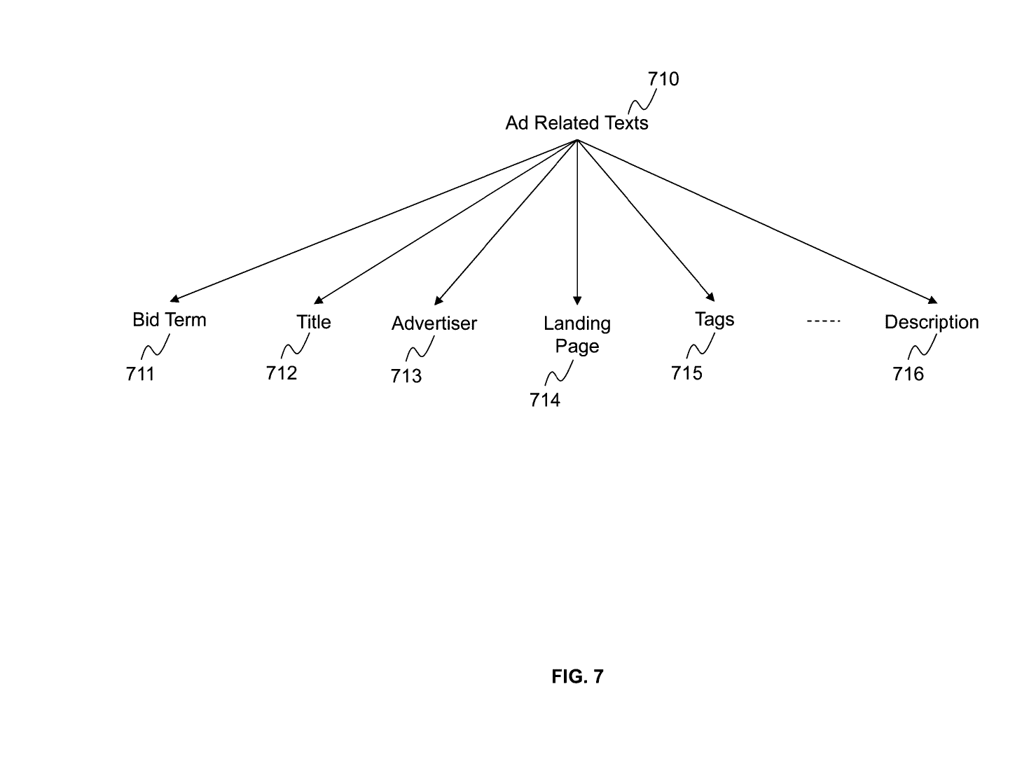

FIG. 7 shows exemplary ad related texts 710 that may be parsed into semantic frames, according to an embodiment of the present teaching. As shown in FIG. 7, an ad related text associated with an advertisement may include a bid term 711 on which an advertiser bids with the advertisement; a title 712 of the advertisement, an advertiser 713 of the advertisement, a landing page 714 associated with the advertisement, a tag 715 associated with the advertisement, and a description 716 of the advertisement. In general, the ad related text may include any text that can represent the advertisement at text token level. According to the semantic rules in the present teaching, each type of ad related text may be converted to semantic frames for data processing at the semantic level.

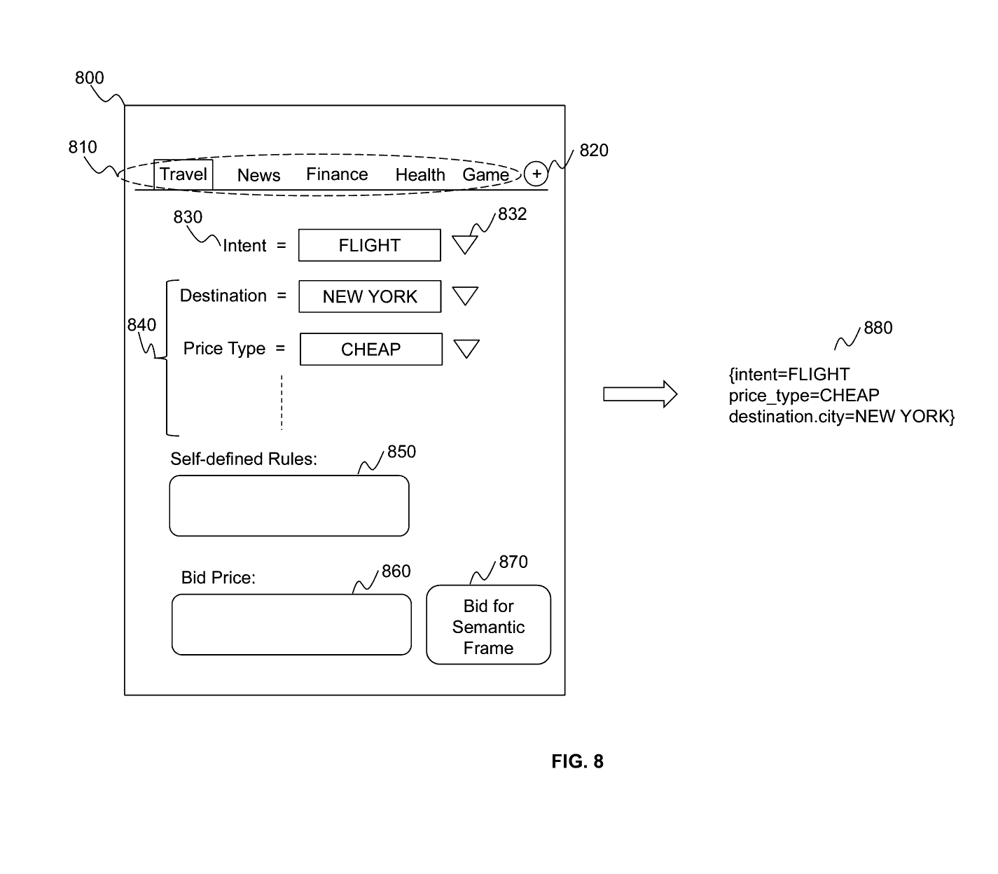

FIG. 8 shows an exemplary user interface 800, when an advertiser bids for a semantic frame, according to an embodiment of the present teaching. According to one embodiment of the present teaching, the system allows advertisers to bid on semantic frames directly. An advertiser can explicitly specify the semantic meanings of the queries or keywords on which the advertiser wants to bid.

For example, on the user interface 800, an advertiser chooses the category Travel in the categories 810. Each category may indicate a category of advertisements. According to one embodiment, an advertiser may add a new category after clicking the button 820.

As shown in FIG. 8, the user interface 800 may also include one or more rule setups 830 840. According to one embodiment, after an advertiser chooses the category Travel, the rule setup for Intent 830 is displayed on the user interface 800. The advertiser may click the arrow 832 to select one of the intents listed there. After the advertiser selects the intent to be FLIGHT, as shown in FIG. 8, more rule setups 840 related to the FLIGHT intent may be displayed on the user interface 800 for the advertiser to specify. Based on the specifications, the system may obtain a semantic frame directly without parsing a text. In the example shown in FIG. 8, the semantic frame 880 may be obtained according to the specification input by the advertiser.

In addition, the advertiser may input self-defined rules in the box 850, and a bid price in the box 860. For example, an advertiser may define an additional rule about “number of stops” under the FLIGHT intent. An advertiser may also define more terminals for an existing rule, e.g. adding “big apple” into the destination rule. In one embodiment, when a self-defined rule from an advertiser is inconsistent with a system-defined rule, the self-defined rule trumps the system-defined rule. In another embodiment, when a self-defined rule from an advertiser is inconsistent with a system-defined rule, the system-defined rule trumps the self-defined rule.

The advertiser may click the button “Bid for Semantic Frame” 870 to submit a bid for the semantic frame specified on the user interface 800. Accordingly, the system may receive one or more bids for the semantic frame 880 in this example, and determine which advertisement is the winner to be associated with the semantic frame 880. Then, when the search engine receives a query or keyword that falls into this semantic frame, e.g. based on parsing, the system will provide the winning advertisement to the search engine to put the winning advertisement into a search result page in response to the query.

It can be understood that in some embodiments, the user interface 800 may also include other components, e.g. information about the advertiser, information about the advertisement to be associated with the semantic frame, a box for an advertiser to specify a period for the bidding advertisement to be associated with the semantic frame, etc. In one example, the above information may be input by the advertiser on other user interfaces.

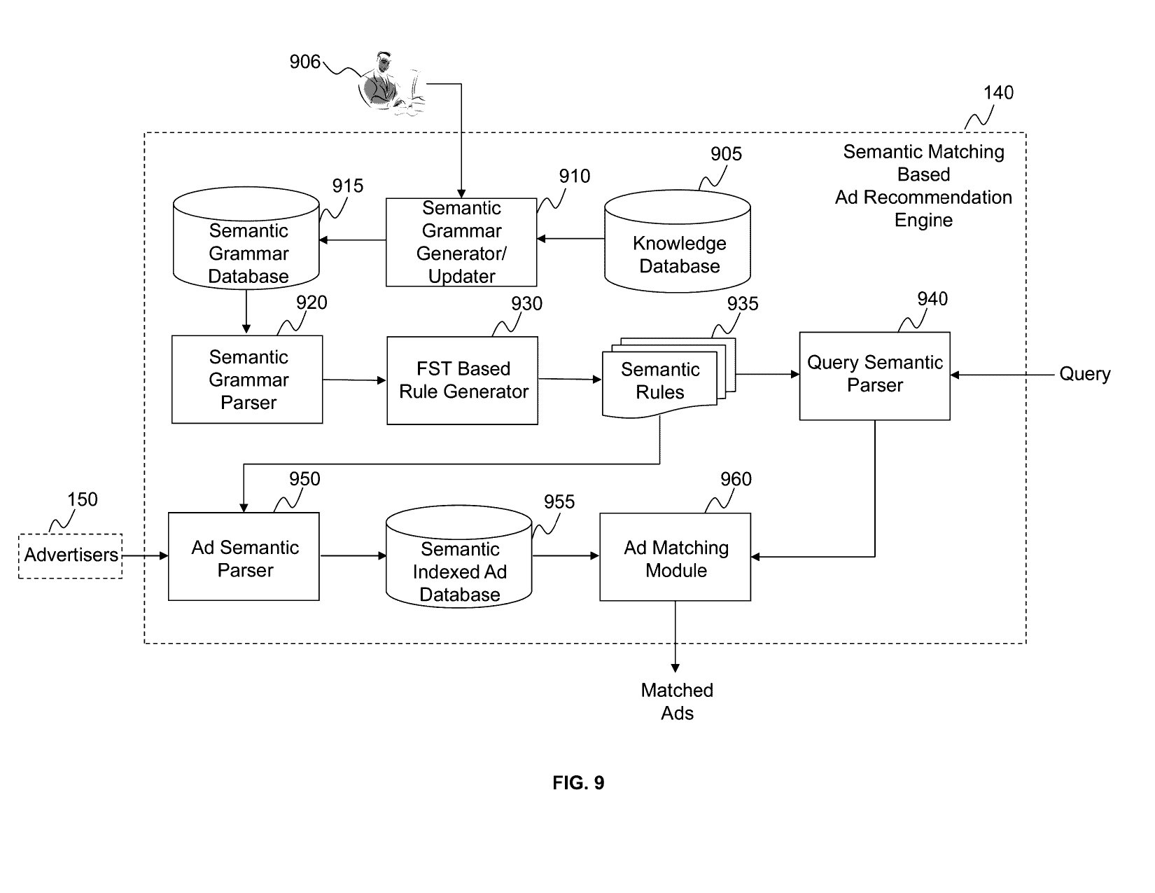

FIG. 9 illustrates an exemplary diagram of a semantic matching based ad recommendation engine 140, according to an embodiment of the present teaching. The semantic matching based ad recommendation engine 140 in this example includes a knowledge database 905, a semantic grammar generator/updater 910, a semantic grammar database 915, a semantic grammar parser 920, an FST based rule generator 930, one or more semantic rules 935, a query semantic parser 940, an ad semantic parser 950, a semantic indexed ad database 955, and an ad matching module 960.

The semantic grammar generator/updater 910 in this example receives inputs from a programmer or manager 906. The inputs may include instructions about how to construct semantic rules and grammar, test code, rule merging instruction, rule split instruction, rule structure configuration, rule confirmation, etc. The semantic grammar generator/updater 910 can generate and/or update semantic grammar stored in the semantic grammar database 915.

In one embodiment, the semantic grammar generator/updater 910 may also retrieve information from the knowledge database 905 to help generating or updating the semantic grammar. For example, the knowledge database 905 may be connected to Wikipedia or any other knowledge data source, from which the semantic grammar generator/updater 910 can obtain a list of all cities in the world, a list of all national parks in United States, and/or a list of all hotel companies. All the information may be utilized by the system to define higher-level rules like “flight to city”, “flight to state, city, hotel” and so on.

The semantic grammar database 915 in this example stores the semantic grammar generated or updated by the semantic grammar generator/updater 910. The semantic grammar parser 920 in this example can parse the semantic grammar in the semantic grammar database 915 and forward the parsed semantic grammar to the FST based rule generator 930 for rule generation based on FST. The FST based rule generator 930 in this example may generate semantic rules based on FSTs. FST may be one method to implement a parser. It can be understood that models other than FST may also be utilized to implement a parser in the present teaching. The FST based rule generator 930 can store all the generated semantic rules 935 at the semantic matching based ad recommendation engine 140.

The query semantic parser 940 in this example may receive a request for advertisements, either from the search engine or from a user directly. The request may be received with a query submitted by the user. For example, a user may submit a query “basketball shoes” to the search engine 130. The search engine 130 can then forward the query to the query semantic parser 940, with a request for one or more advertisements or sponsored search results in response to the query. The query semantic parser 940 may parse the query with corresponding semantic rules 935 to generate a semantic representation for the query. For example, the query “basketball shoes” may be converted into the semantic frame “intent:=SHOES; category:=BASKETBALL”. The query semantic parser 940 may then send the semantic frame to the ad matching module 960 for determining advertisements based on the semantic frame.

The ad semantic parser 950 in this example may receive advertisements submitted by the advertisers 150. As discussed above, the ad semantic parser 950 may receive the advertisements with other inputs from the advertisers during a bidding process. The other inputs may include information about ad related text, e.g. a bid term on which an advertiser bids with the advertisement, a title of the advertisement, the advertiser of the advertisement, a landing page associated with the advertisement, a tag associated with the advertisement, a description of the advertisement, or any other text that can represent the advertisement.

The ad semantic parser 950 may select corresponding semantic rules 935 and utilize the selected semantic rules to parse the ad related text into semantic frames that can represent the advertisements. Then, the ad semantic parser 950 may index the advertisements based on the generated semantic frames and stores them into the semantic indexed ad database 955.

The semantic indexed ad database 955 in this example stores the advertisements indexed by their respective semantic frames. In one embodiment, the semantic frames of the advertisements are of a same type, i.e. all semantic frames are generated based on a same type of ad related text: bid terms, titles, advertisers, landing pages, tags, or descriptions. In another embodiment, the semantic frames of the advertisements may be of different types, i.e. the semantic frames are generated based on different types of ad related text.

The ad matching module 960 in this example receives the semantic frame representing the query from the query semantic parser 940. Based on the query semantic frame, the ad matching module 960 may determine one or more advertisements from the semantic indexed ad database 955 for presenting to the user in a search result page. For example, the ad matching module 960 may select one or more advertisements that have semantic frames matching the query semantic frame. In one embodiment, the ad matching module 960 may perform the semantic matching based on an exact match between the query semantic frame and the semantic frames of the selected advertisements. In another embodiment, the ad matching module 960 may perform the semantic matching based on ranking the scores of matching between the query semantic frame and the semantic frames of the selected advertisements. For example, regarding a query semantic frame “intent:=SHOES; category:=BASKETBALL”, the semantic frame “intent:=SHOES; category:=SPORT” may have a higher matching score than the semantic frame “intent:=SHOES; category:=MEN”. After determining the one or more advertisements matching the query at the semantic level, the ad matching module 960 may send the one or more advertisements with some metadata to the search engine 130. The metadata may include information about how to present the advertisements, e.g. location in a search result page.

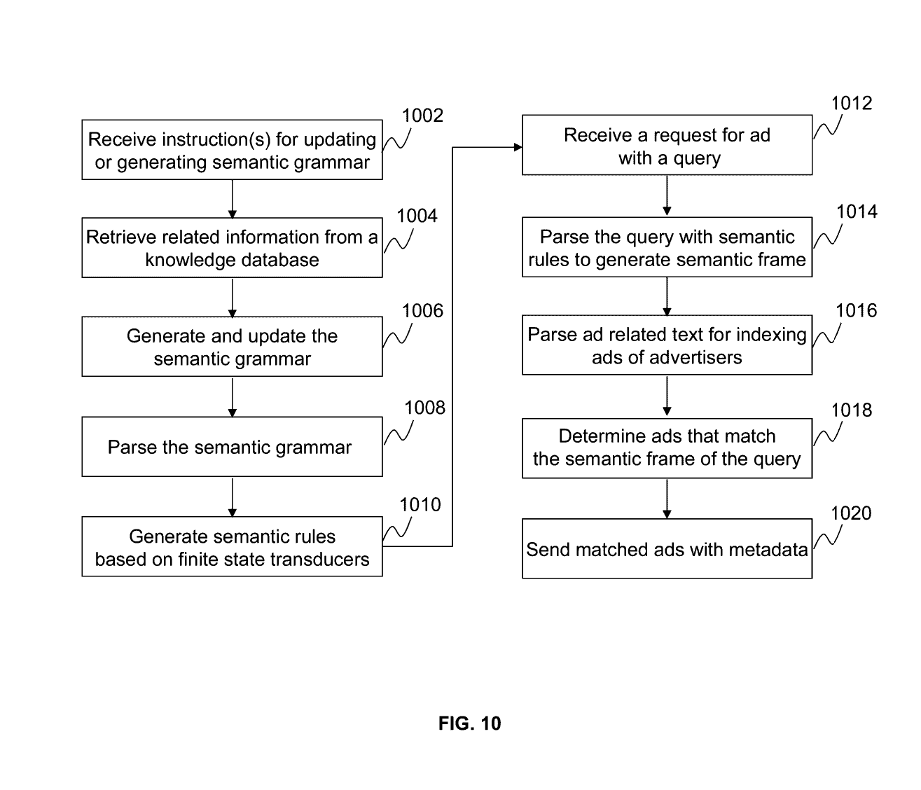

FIG. 10 is a flowchart of an exemplary process performed by a semantic matching based ad recommendation engine, e.g. the semantic matching based ad recommendation engine 140 in FIG. 9, according to an embodiment of the present teaching. One or more instructions are received at 1002 for updating or generating semantic grammar. Related information is retrieved at 1004 from a knowledge database. The semantic grammar is generated or updated at 1006, based on the instructions and/or the related information. At 1008, the semantic grammar is parsed. Semantic rules are generated at 1010, e.g. based on finite state transducers.

A request for ad is received at 1012 with a query. The query is parsed at 1014 based on corresponding semantic rules to generate a query semantic frame representing the query. At 1016, advertisement related text is parsed for indexing the ads of advertisers. At 1018, one or more advertisements are determined to match the query at the semantic frame level, e.g. when the one or more advertisements have the same or similar semantic frames as the query. The one or more advertisements are sent with metadata at 1020 to a search engine for presenting to the user in a search result page.

It can be understood that the order of the steps shown in FIG. 10 may be changed according to different embodiments of the present teaching.

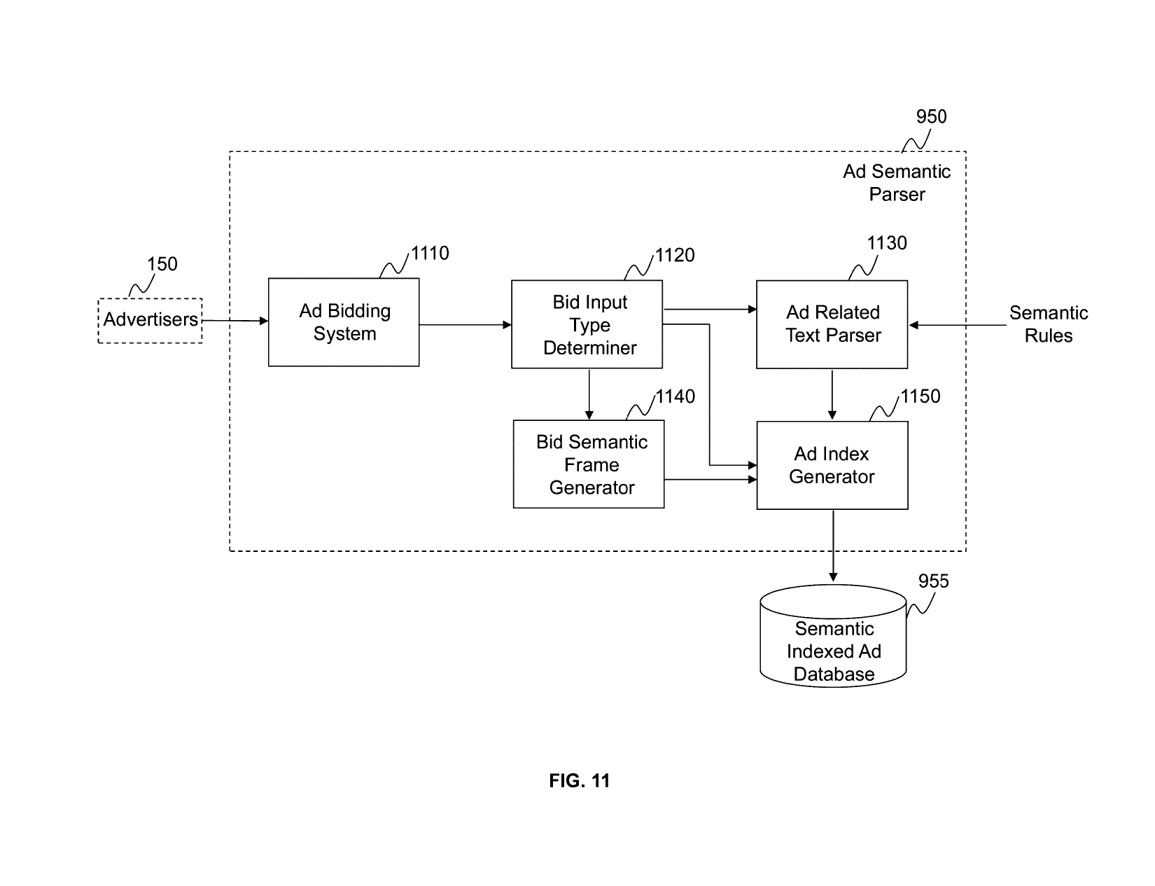

FIG. 11 illustrates an exemplary diagram of an ad semantic parser 950, according to an embodiment of the present teaching. The ad semantic parser 950 in this example includes an ad bidding system 1110, a bid input type determiner 1120, an ad related text parser 1130, a bid semantic frame generator 1140, and an ad index generator 1150.

The ad bidding system 1110 in this example receives bid related information from the advertisers 150 and performs a bidding process to determine winning advertisers and advertisements for each ad opportunity, e.g. an ad space in a web page or a search result page. The ad bidding system 1110 may associate winning ads with ad opportunities based on the bidding process and forward inputs from the advertisers who submitted winning ads to the bid input type determiner 1120.

The bid input type determiner 1120 in this example determines a type of the bid input from each advertiser. An advertiser may submit a bid for an advertisement with a text bid term or with a semantic frame directly as shown in FIG. 8. The type of the bid input is determined by the bid input type determiner 1120 to indicate whether an advertisement is bid with a text token bid term like “affordable flight to NYC” or with a semantic frame like {intent=FLIGHT; price_type=CHEAP; destination.city=NEW YORK}.

If the type of the bid input indicates a text token bid term, the bid input type determiner 1120 may send the bid input to the ad related text parser 1130 for parsing ad related text. If the type of the bid input indicates a semantic frame, the bid input type determiner 1120 may send the bid input to the bid semantic frame generator 1140 for obtaining or generating a semantic frame directly from the bid input. The bid input type determiner 1120 may also forward the winning advertisements to the ad index generator 1150 for generating ad indices.

The ad related text parser 1130 in this example can receive ad related text, e.g. text bid terms from the bid input type determiner 1120 and parse the ad related text to generate semantic frames based on corresponding semantic rules. For example, a text bid term “affordable flight to NYC” may be parsed into the semantic frame {intent=FLIGHT; price_type=CHEAP; destination.city=NEW YORK}, according semantic rules shown in FIG. 3. The ad related text parser 1130 may then send the semantic frames generated based on ad related texts to the ad index generator 1150.

The bid semantic frame generator 1140 in this example can receive bid input from the bid input type determiner 1120 and obtain or generate a semantic frame directly from the bid input. For example, based on the bid input on the user interface 800 from an advertiser, the bid semantic frame generator 1140 may generate the semantic frame {intent=FLIGHT; price_type=CHEAP; destination.city=NEW YORK} 880 as shown in FIG. 8 without parsing any text. The bid semantic frame generator 1140 may then send the semantic frames generated based on bid inputs to the ad index generator 1150.

The ad index generator 1150 in this example receives the winning advertisements from the bid input type determiner 1120 and receives the semantic frames representing the winning advertisements from the ad related text parser 1130 and/or the bid semantic frame generator 1140. The ad index generator 1150 can generate indices for the winning advertisements based on their respective semantic frames, such that the winning advertisements are indexed by their respective semantic frames. The ad index generator 1150 may then store the indexed winning advertisements in association with the corresponding semantic frames and other metadata into the semantic indexed ad database 955. Because the advertisements in the semantic indexed ad database 955 are indexed by their respective semantic frames, the advertisements can be easily retrieved and sorted based on the semantic frames.

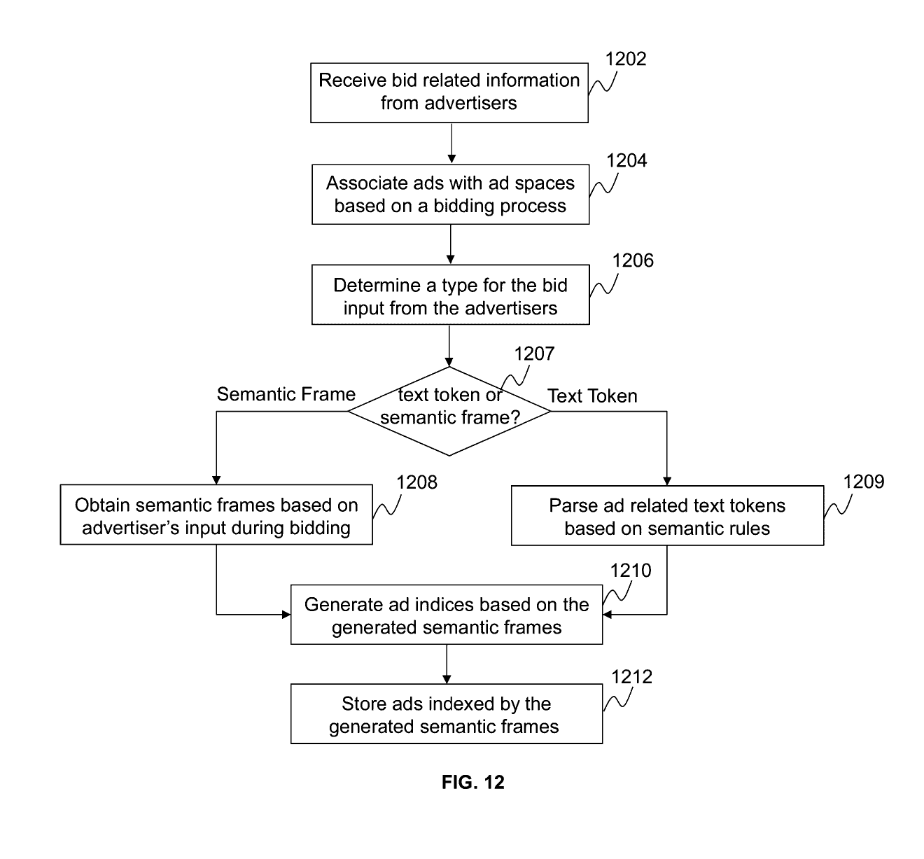

FIG. 12 is a flowchart of an exemplary process performed by an ad semantic parser, e.g. the ad semantic parser 950 in FIG. 11, according to an embodiment of the present teaching. Bid related information is received at 1202 from advertisers with respect to ad opportunities, e.g. ad spaces. Each ad space is associated at 1204 with a winning advertisement based on a bidding process. At 1206, a type for the bid input from each advertiser is determined.

It is determined at 1207 that whether the type of a bid input indicates an ad related text, e.g. a text token bid term, or a semantic frame. If the type of a bid input indicates an ad related text, the process goes to 1209, where ad related text tokens are parsed based on semantic rules to generate semantic frames; and the process then moves on to 1210. If the type of a bid input indicates a semantic frame, the process goes to 1208, where semantic frames are obtained directly based on the advertiser's input during bidding; and the process then moves on to 1210. At 1210, ad indices are generated based on the generated or obtained semantic frames. The advertisements are indexed by the semantic frames and stored at 1212.

It can be understood that the order of the steps shown in FIG. 12 may be changed according to different embodiments of the present teaching.

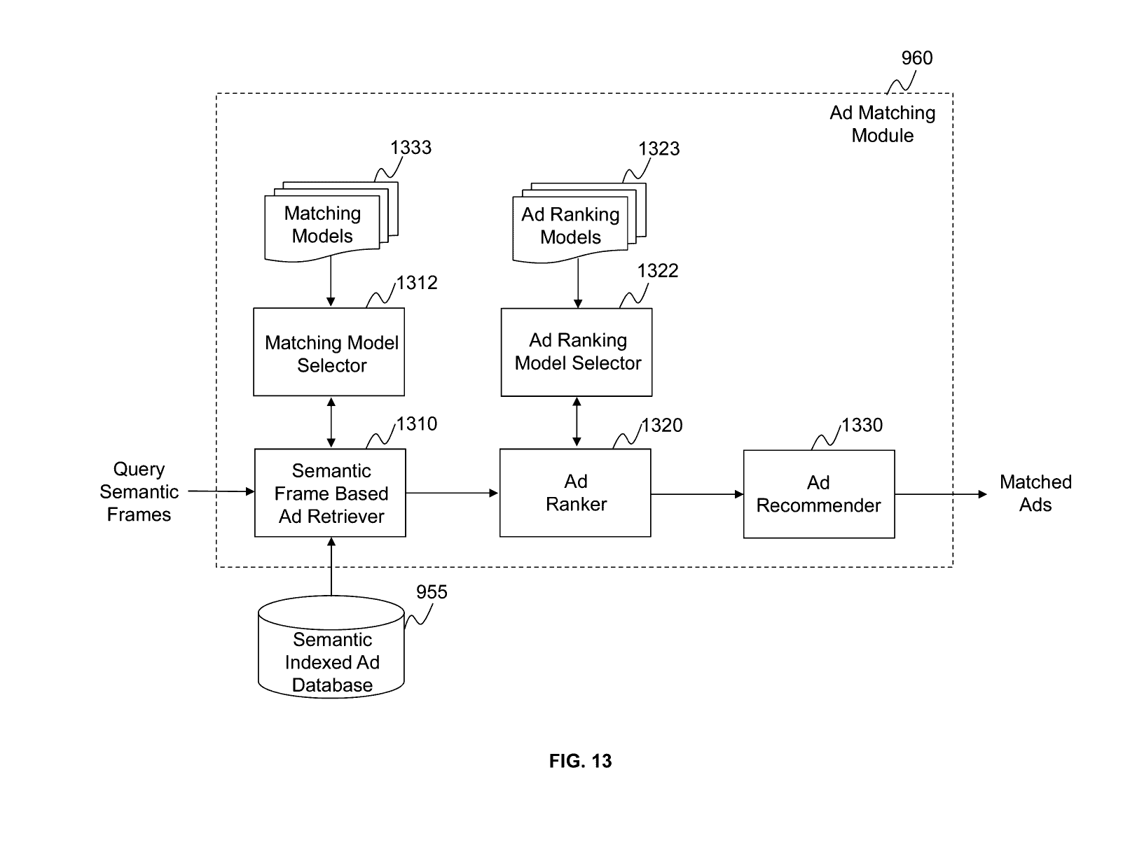

FIG. 13 illustrates an exemplary diagram of an ad matching module 960, according to an embodiment of the present teaching. The ad matching module 960 in this example includes a semantic frame based ad retriever 1310, a matching model selector 1312, an ad ranker 1320, an ad ranking model selector 1322, one or more ad ranking models 1323, one or more matching models 1333, and an ad recommender 1330.

The semantic frame based ad retriever 1310 in this example can receive query semantic frames from the query semantic parser 940. Each query semantic frame represents a query at semantic level. Based on the query semantic frame, the semantic frame based ad retriever 1310 can determine advertisements in the semantic indexed ad database 955 that match the query at the semantic level. Because the advertisements in the semantic indexed ad database 955 are indexed by their respective semantic frames, the advertisements can be easily retrieved and sorted based on the semantic frames.

In one embodiment, after receiving a query semantic frame for a query, the semantic frame based ad retriever 1310 may inform the matching model selector 1312 to select one of the matching models 1333. The matching model selector 1312 in this example may select a matching model to indicate how to determine a matching advertisement based on a query. In one example, a matching model may require an exact match between the query semantic frame and the ad semantic frames to determine the matching ads. In another example, a matching model may indicate to find one or more advertisements whose semantic frames are best matching the query semantic frame among all the advertisements in the semantic indexed ad database 955. For example, the semantic frame based ad retriever 1310 may use the matching model to select top three advertisements whose semantic frames have top three matching scores with respect to the query semantic frame, among all the advertisements in the semantic indexed ad database 955. A matching score may be any numeric number that indicates a degree of similarity between two semantic frames, e.g. based on a percentage of common components within the two semantic frames. In another example, the system may represent each semantic frame as a vector, such that the system can determine a matching score for two semantic frames based on the Euclidean distance between the two semantic frames' respective vectors.

The matching model selector 1312 may select the matching model based on the query semantic frame. For example, for a query semantic frame including a specific brand, the matching model selector 1312 may select a matching model for an exact match regarding the specific brand. For a query semantic frame including a general intent like “sport”, the matching model selector 1312 may select a matching model that allows similar match regarding the “sport” intent, e.g. “intent:=BASKETBALL” “intent:=FOOTBALL” may also be considered a match in this case.

The matching model selector 1312 may send the selected matching model to the semantic frame based ad retriever 1310. Based on the selected matching model, the semantic frame based ad retriever 1310 may retrieve matching advertisements for each query semantic frame, and send the retrieved advertisements to the ad ranker 1320.

The ad ranker 1320 in this example can rank the retrieved advertisements based on an ad ranking model selected by the ad ranking model selector 1322. The ad ranking model selector 1322 in this example selects one of the ad ranking models 1323 and sends it to the ad ranker 1320. An ad ranking model may indicate how to rank different advertisements retrieved based on one query semantic frame. In one example, an ad ranking model may indicate to rank the different advertisements based on their respective matching scores with respect to the query semantic frame, e.g. advertisement with higher matching score is ranked higher. In another example, an ad ranking model may indicate to rank the different advertisements based on their bid prices submitted during the bidding process, e.g. advertisement with higher bid price is ranked higher. In yet another example, a description for each of the retrieved advertisements may be parsed to generate many semantic frames for representing the advertisement. Then an ad ranking model may indicate to rank the retrieved advertisements based on how many times the query semantic frame appears in each advertisement. In still another example, an ad ranking model may indicate to rank the retrieved advertisements based on likelihood for a user to click on each advertisement after the advertisement is presented to the user, which may be determined based on the user's personal information and/or the user's past online behavior.

The ad ranking model selector 1322 may select the ad ranking model based on the query semantic frame forwarded by the ad ranker 1320. For example, for a query semantic frame including a specific brand, the ad ranking model selector 1322 may select an ad ranking model for ranking the advertisements based on matching scores. For a query semantic frame including a general intent like “smartphone”, the ad ranking model selector 1322 may select an ad ranking model for ranking the advertisements based on their respective bid prices, so long as the advertisements have been retrieved by the semantic frame based ad retriever 1310 based on a matching model.

The ad ranking model selector 1322 may send the selected ad ranking model to the ad ranker 1320. Based on the selected ad ranking model, the ad ranker 1320 may rank the retrieved advertisements and send the ranked advertisements to the ad recommender 1330.

The ad recommender 1330 in this example can select one or more advertisements based on the ranking and send the selected one or more advertisements to the search engine 130 to be presented in a search result page. For example, the ad recommender 1330 may select the top one or more advertisements in the ranking with respect to a query, and provide them to be presented in response to the query. The ad recommender 1330 may also provide metadata associated with the one or more advertisements, to indicate how to present the one or more advertisements, in a web page or search result page.

It can be understood that the ad recommender 1330 may also send the query semantic frame to the search engine 130 such that the search engine 130 can perform query rewrite or query suggestion based on the query semantic frame. For example, after a user inputs a query term at the search engine 130, the search engine 130 can obtain the semantic frame corresponding to the query term and suggest other query terms falling into the semantic frame to the user, with the help of the semantic matching based ad recommendation engine 140.

It can also be understood that, in addition to the query itself, the semantic matching based ad recommendation engine 140 may also receive documents in the search results in response to the query from the search engine 130. The semantic matching based ad recommendation engine 140 may parse each document to generate its semantic frames that can represent the document. Based on the generated semantic frames for each document, the search engine 130 may rank the documents in the search results at the semantic frame level. For example, the search engine 130 is trying to give a document higher rank when it is more relevant to the query. But instead of operating at the text token level to count how many times the query terms are mentioned in the document, the search engine 130 may count how many times the query semantic frame appears in the document, based on the semantic frames generated for each document by the semantic matching based ad recommendation engine 140. Then the search engine 130 may rank a first document higher than a second document when the query semantic frame appears more times in the first document than in the second document.

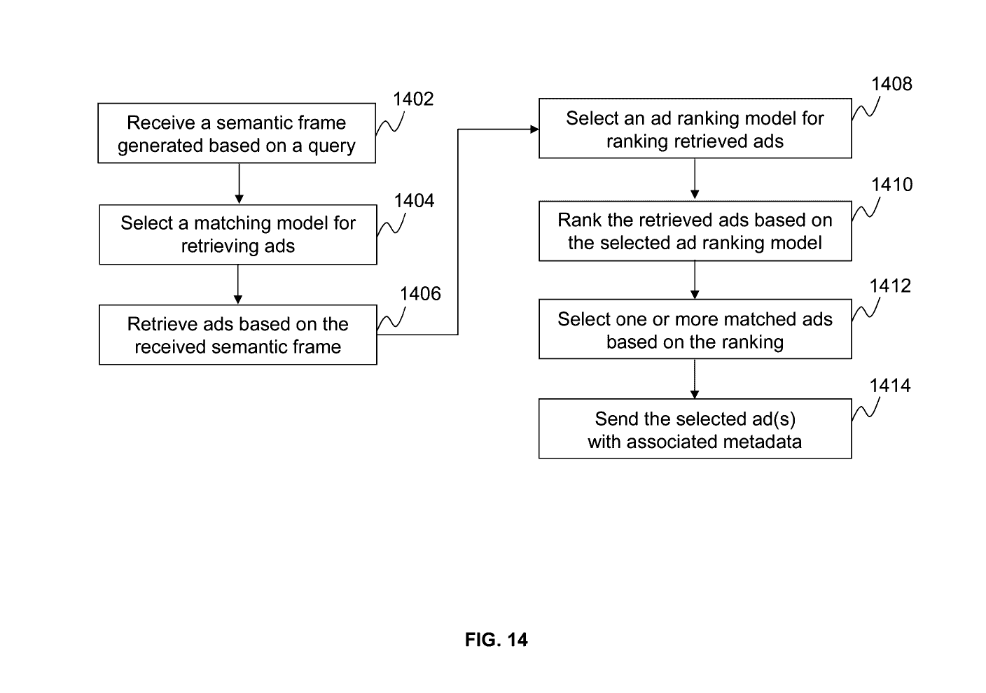

FIG. 14 is a flowchart of an exemplary process performed by an ad matching module, e.g. the ad matching module 960 in FIG. 13, according to an embodiment of the present teaching. At 1402, a semantic frame generated based on a query is received. A matching model is selected at 1404 for retrieving ads. Ads are retrieved at 1406 based on the received query semantic frame.

An ad ranking model is selected at 1408 for ranking the retrieved ads. The retrieved ads are ranked at 1410 based on the selected ad ranking model. At 1412, one or more matched ads are selected based on the ranking. The selected one or more ads are sent at 1414 with associated metadata for presenting to a user.

It can be understood that the order of the steps shown in FIG. 14 may be changed according to different embodiments of the present teaching.

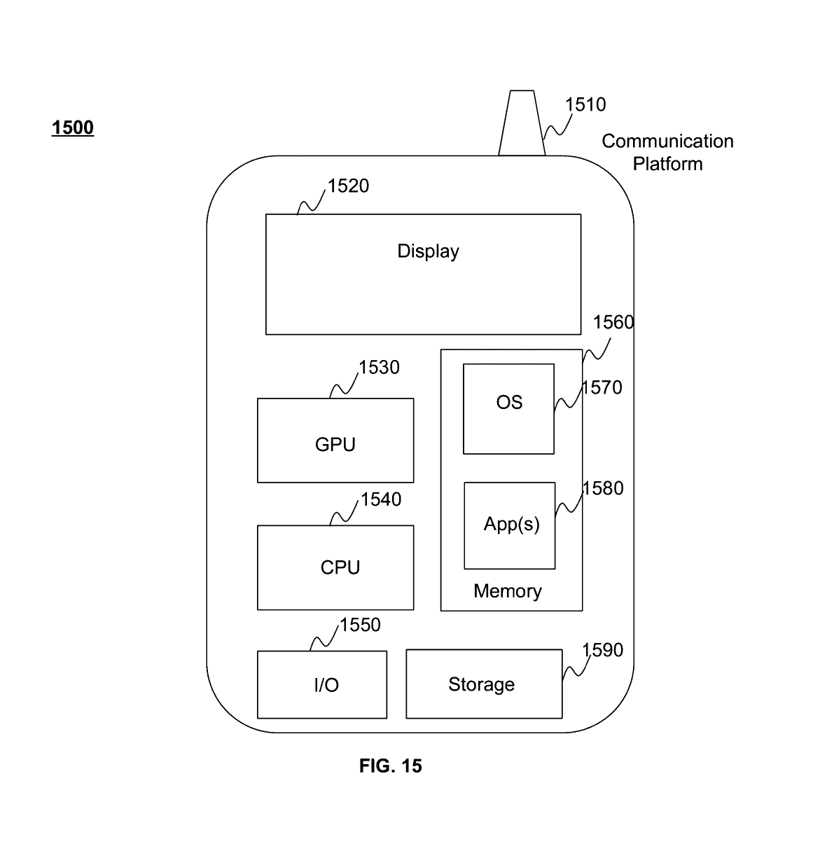

FIG. 15 depicts the architecture of a mobile device which can be used to realize a specialized system implementing the present teaching. In this example, the user device on which advertisements are presented and interacted-with is a mobile device 1500, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1500 in this example includes one or more central processing units (CPUs) 1540, one or more graphic processing units (GPUs) 1530, a display 1520, a memory 1560, a communication platform 1510, such as a wireless communication module, storage 1590, and one or more input/output (I/O) devices 1550. Any other suitable component, including but not limited to a system bus or a controller (not shown), may also be included in the mobile device 1500. As shown in FIG. 15, a mobile operating system 1570, e.g., iOS, Android, Windows Phone, etc., and one or more applications 1580 may be loaded into the memory 1560 from the storage 1590 in order to be executed by the CPU 1540. The applications 1580 may include a browser or any other suitable mobile apps for receiving advertisements on the mobile device 1500. User interactions with the advertisements or other content items may be achieved via the I/O devices 1550 and provided to the semantic matching based ad recommendation engine 140 and/or other components of systems 100 and 200, e.g., via the network 120.

To implement various modules, units, and their functionalities described in the present disclosure, computer hardware platforms may be used as the hardware platform(s) for one or more of the elements described herein (e.g., the semantic matching based ad recommendation engine 140 and/or other components of systems 100 and 200 described with respect to FIGS. 1-14). The hardware elements, operating systems and programming languages of such computers are conventional in nature, and it is presumed that those skilled in the art are adequately familiar therewith to adapt those technologies to selecting and providing an advertisement as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

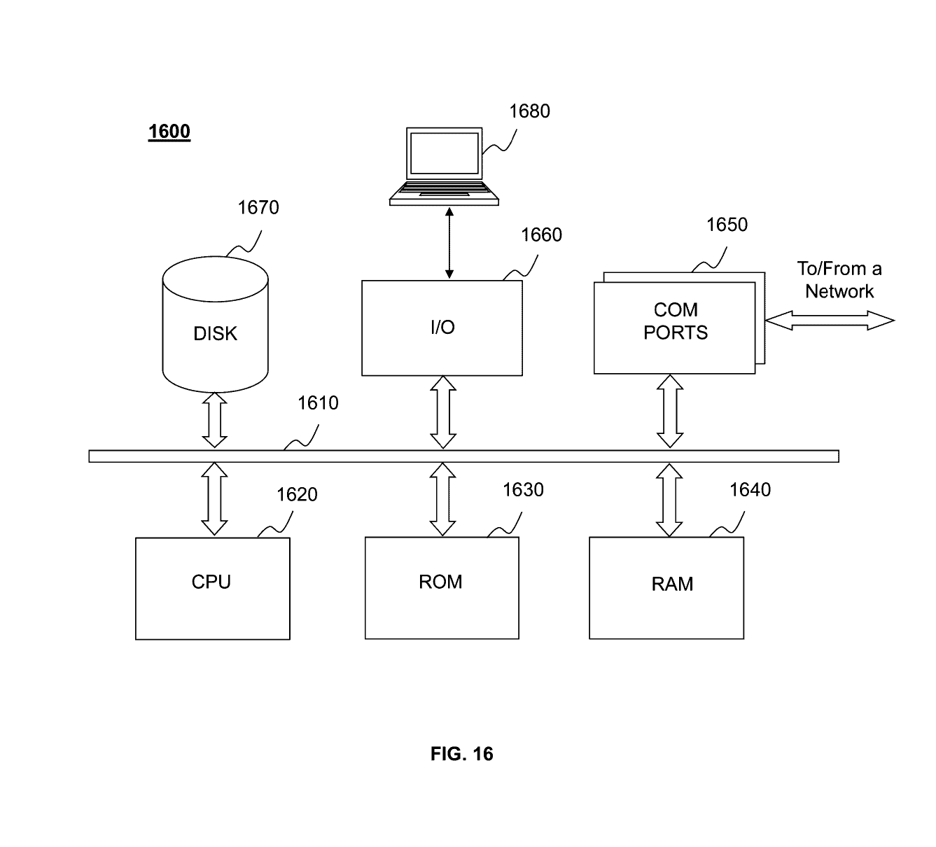

FIG. 16 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1600 may be used to implement any component of the semantic matching based advertisement selection techniques, as described herein. For example, the semantic matching based ad recommendation engine 140, etc., may be implemented on a computer such as computer 1600, via its hardware, software program, firmware, or a combination thereof. Although only one such computer is shown, for convenience, the computer functions relating to semantic matching based advertisement selection as described herein may be implemented in a distributed fashion on a number of similar platforms, to distribute the processing load.

The computer 1600, for example, includes COM ports 1650 connected to and from a network connected thereto to facilitate data communications. The computer 1600 also includes a central processing unit (CPU) 1620, in the form of one or more processors, for executing program instructions. The exemplary computer platform includes an internal communication bus 1610, program storage and data storage of different forms, e.g., disk 1670, read only memory (ROM) 1630, or random access memory (RAM) 1640, for various data files to be processed and/or communicated by the computer, as well as possibly program instructions to be executed by the CPU. The computer 1600 also includes an I/O component 1660, supporting input/output flows between the computer and other components therein such as user interface elements 1680. The computer 1600 may also receive programming and data via network communications.

Hence, aspects of the methods of semantic matching based advertisement selection, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer into the hardware platform(s) of a computing environment or other system implementing a computing environment or similar functionalities in connection with semantic matching based advertisement selection. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the semantic matching based advertisement selection as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on a machine having at least one processor, storage, and a communication platform connected to a network for providing advertisement, the method comprising:
obtaining a request for advertisement, wherein the request incorporates a query;
parsing the query to generate a semantic representation of the query;
obtaining a plurality of advertisements indexed by their respective semantic representations;
determining, among the plurality of advertisements, one or more advertisements whose semantic representations match the semantic representation of the query; and
providing the one or more advertisements as a response to the request.

2. The method of claim 1, further comprising:
receiving bid related inputs from advertisers of the plurality of advertisements based on a bidding process, wherein each bid related input corresponds to an advertisement;
obtaining a semantic representation of each advertisement based on the bid related input corresponding to the advertisement; and
indexing the plurality of advertisements based on their respective semantic representations.

3. The method of claim 2, wherein the bid related input corresponding to the advertisement includes the advertisement's semantic representation input by an advertiser of the advertisement during the bidding process.

4. The method of claim 2, further comprising parsing text related to each advertisement to generate the semantic representation of the advertisement.

5. The method of claim 4, wherein the text related to each advertisement includes information about at least one of the following: a bid term on which an advertiser bids with the advertisement, a title of the advertisement, an advertiser of the advertisement, a landing page associated with the advertisement, a tag associated with the advertisement, and a description of the advertisement.

6. The method of claim 1, wherein determining the one or more advertisements comprises:
determining a matching score based on a degree of similarity between the semantic representation of the query and the semantic representation of each of the plurality of advertisements;
ranking the plurality of advertisements based on their respective matching scores; and
selecting the one or more advertisements from the plurality of advertisements based on the ranking.

7. The method of claim 1, wherein the query is parsed based on one or more semantic rules.

8. The method of claim 7, further comprising:
parsing semantic grammar stored in a semantic grammar database; and
generating the one or more semantic rules based on the parsed semantic grammar and at least one finite state transducer.

9. The method of claim 8, further comprising updating the semantic grammar stored in the semantic grammar database based on information retrieved from a knowledge database.

10. A system having at least one processor, storage, and a communication platform connected to a network for providing advertisement, the system comprising:
a query semantic parser configured for obtaining a request for advertisement, wherein the request incorporates a query; and parsing the query to generate a semantic representation of the query; and
an ad matching module configured for obtaining a plurality of advertisements indexed by their respective semantic representations; determining, among the plurality of advertisements, one or more advertisements whose semantic representations match the semantic representation of the query; and providing the one or more advertisements as a response to the request.

11. The system of claim 10, further comprising an ad semantic parser configured for:
receiving bid related inputs from advertisers of the plurality of advertisements based on a bidding process, wherein each bid related input corresponds to an advertisement;
obtaining a semantic representation of each advertisement based on the bid related input corresponding to the advertisement; and
indexing the plurality of advertisements based on their respective semantic representations.

12. The system of claim 11, wherein the bid related input corresponding to the advertisement includes the advertisement's semantic representation input by an advertiser of the advertisement during the bidding process.

13. The system of claim 11, wherein the ad semantic parser further comprises an ad related text parser configured for parsing text related to each advertisement to generate the semantic representation of the advertisement.

14. The system of claim 13, wherein the text related to each advertisement includes information about at least one of the following: a bid term on which an advertiser bids with the advertisement, a title of the advertisement, an advertiser of the advertisement, a landing page associated with the advertisement, a tag associated with the advertisement, and a description of the advertisement.

15. The system of claim 10, wherein the ad matching module comprises:
a semantic frame based ad retriever configured for determining a matching score based on a degree of similarity between the semantic representation of the query and the semantic representation of each of the plurality of advertisements;
an ad ranker configured for ranking the plurality of advertisements based on their respective matching scores; and
an ad recommender configured for selecting the one or more advertisements from the plurality of advertisements based on the ranking.

16. The system of claim 10, wherein the query is parsed based on one or more semantic rules.

17. The system of claim 16, further comprising:
a semantic grammar parser configured for parsing semantic grammar stored in a semantic grammar database; and
an FST based rule generator configured for generating the one or more semantic rules based on the parsed semantic grammar and at least one finite state transducer.

18. The system of claim 17, further comprising a semantic grammar generator/updater configured for updating the semantic grammar stored in the semantic grammar database based on information retrieved from a knowledge database.

19. A machine-readable, non-transitory and tangible medium having information recorded thereon for providing advertisement, the information, when read by the machine, causes the machine to perform the following:
obtaining a request for advertisement, wherein the request incorporates a query;
parsing the query to generate a semantic representation of the query;
obtaining a plurality of advertisements indexed by their respective semantic representations;
determining, among the plurality of advertisements, one or more advertisements whose semantic representations match the semantic representation of the query; and
providing the one or more advertisements as a response to the request.

20. The medium of claim 19, wherein the information, when read by the machine, further causes the machine to perform the following:
receiving bid related inputs from advertisers of the plurality of advertisements based on a bidding process, wherein each bid related input corresponds to an advertisement;
obtaining a semantic representation of each advertisement based on the bid related input corresponding to the advertisement; and
indexing the plurality of advertisements based on their respective semantic representations.

21. The medium of claim 20, wherein the bid related input corresponding to the advertisement includes the advertisement's semantic representation input by an advertiser of the advertisement during the bidding process.

22. The medium of claim 20, wherein the information, when read by the machine, further causes the machine to perform the following: parsing text related to each advertisement to generate the semantic representation of the advertisement.

23. The medium of claim 22, wherein the text related to each advertisement includes information about at least one of the following: a bid term on which an advertiser bids with the advertisement, a title of the advertisement, an advertiser of the advertisement, a landing page associated with the advertisement, a tag associated with the advertisement, and a description of the advertisement.
